(19) United States
(12) Patent Application Publication
(10) Pub. No.: US 2024/0056193 A1
(43) Pub. Date: Feb. 15, 2024

(54) OPTICAL TRANSMITTING APPARATUS AND SIGNAL DETECTION METHOD

(71) Applicant: NIPPON TELEGRAPH AND TELEPHONE CORPORATION, Tokyo (JP)

(72) Inventors: Akihiro TANABE, Musashino-shi, Tokyo (JP); Toshiaki SHITABA, Musashino-shi, Tokyo (JP); Yoichi FUKADA, Musashino-shi, Tokyo (JP); Ryo MIYATAKE, Musashino-shi, Tokyo (JP); Tomoaki YOSHIDA, Musashino-shi, Tokyo (JP)

(73) Assignee: NIPPON TELEGRAPH AND TELEPHONE CORPORATION, Tokyo (JP)

(21) Appl. No.: 18/269,491

(22) PCT Filed: Dec. 28, 2020
(86) PCT No.: PCT/JP2020/049138

§ 371 Date: Jun. 23, 2023

(51) Int. Cl. H04B 10/516

(52) U.S. Cl. CPC H04B 10/516

(57) ABSTRACT

An optical transmission device includes: an FM batch conversion unit that performs FM batch conversion on a carrier signal input from the outside, to generate an FM batch conversion signal; a signal branching unit that causes the FM batch conversion signal to branch into a first path and a second path; an optical transmission unit that is provided in the first path, converts the FM batch conversion signal into an optical signal, and transmits the optical signal to the outside; and a detection unit that is provided in the second path, and detects quality degradation of the FM batch conversion signal on the basis of the signal level of the FM batch conversion signal.

### TECHNICAL FIELD

The present invention relates to an optical transmission device and a signal detection method.

### BACKGROUND ART

In a case where signals of a video image or the like are transmitted by frequency division multiplexing (hereinafter also referred to as “FDM”), individual services defined in a certain service category are allocated to the respective frequency bands. For example, in the case of the service category of television broadcasting, “channels” are defined as the individual services, and therefore, “channels” are allocated to the respective frequency bands.

Television broadcasting is conducted with the use of radio waves propagating in the air in some cases, is conducted with the use of electric wires in other cases as in common antenna television (CATV), and is performed with the use of optical communication lines in yet other cases as in a communication system to which an intensity modulation technique or a frequency modulation (FM) batch conversion technique specified in Non Patent Literatures 1 and 2 is applied.

An outline of an optical transmission device 200 in a communication system to which an FM batch conversion technique is applied is now described with reference to FIG. 6. The optical transmission device 200 performs FM batch conversion on a carrier signal c input from the outside, to generate an FM batch conversion signal that is a broadband FM signal. The carrier signal c input from the outside is a carrier signal obtained from a video signal, for example. The optical transmission device 200 includes an electrical signal input unit 201, an FM batch conversion unit 202, an E/O conversion unit 203, a transmission unit 204, and a control unit 205.

The electrical signal input unit 201 receives an input of the carrier signal c that is an electrical signal. The FM batch conversion unit 202 performs FM batch conversion on one or more input carrier signals c, to generate one FM batch conversion signal. The E/O conversion unit 203 converts the FM batch conversion signal, which is an electrical signal, into an optical signal. The transmission unit 204 transmits the converted optical signal to the outside. The control unit 205 controls the respective functional units.

In the conventional optical transmission device 200 as described above, an appropriate center frequency of (c) of an FM batch conversion signal should be provided in accordance with the carrier signal c. In the conventional optical transmission device 200, however, a fixed value OF is provided (see Non Patent Literature 1, for example). In a case where the appropriate center frequency of (c) is higher than the fixed value OF, the low frequency component turns into aliasing, and degrades signal quality (see Non Patent Literature 2, for example). A case where the appropriate center frequency of (c) is higher than the fixed value OF is a case where the actual center frequency of the device is lower than the appropriate value.

For example, the center frequency of (c) of the FM batch conversion signal to be generated is the same, regardless of whether a carrier signal c1 illustrated as Example 1 or a carrier signal c2 illustrated as Example 2 is input to the optical transmission device 200 illustrated in FIG. 6. As illustrated in FIG. 6(A), when the appropriate center frequency of (c1) of the FM batch conversion signal generated on the basis of the carrier signal c1 is equal to the fixed value OF, aliasing of the low frequency component does not occur in the FM batch conversion signal. However, as illustrated in FIG. 6(B), in a case where the appropriate center frequency of (c2) of the FM batch conversion signal generated on the basis of the carrier signal c2 is higher than the fixed value OF, the low frequency component turns into aliasing, and signal quality is degraded.

### CITATION LIST

### Non Patent Literature

Non Patent Literature 1: “Transmission equipment for transferring multi-channel television signals over optical access networks by frequency modulation conversion”, ITU-T Rec. J. 185, 2012.
Non Patent Literature 2: Shibata et al., “Optical Video Distribution Systems Employing FM Conversion”, The IEICE Transactions on Communications. B, Vol. J83-B, No. 7, pp. 948-959, July 2000

### SUMMARY OF INVENTION

### Technical Problem

However, the conventional optical transmission device 200 does not have any mechanism for detecting an aliasing component, and therefore, is incapable of detecting abnormality in an FM batch conversion signal. Because of this, transmission is performed with degraded signal quality. As a result, in a case where the carrier signal c is a video signal, for example, there is a possibility that the video image cannot be correctly viewed when the FM batch conversion signal is demodulated by a device at the transmission destination.

It is possible to solve such a problem by setting the fixed value OF to an optimum value, as long as the carrier signal to be input is always the same. However, when the highest frequency of the input carrier signal becomes higher, the optimum center frequency also becomes higher, leading to signal quality degradation. As an example, the value of the fixed value OF is set to the center frequency having the highest frequency adjusted to 2.1 GHz, which is the intermediate frequency (IF) band of clockwise circularly polarized waves of satellite broadcasting. In this case, when a broadcast signal using counterclockwise circularly polarized waves of satellite broadcasting is erroneously input, the highest frequency of the input signal rises to 3.2 GHz band, which is the IF band of the counterclockwise circularly polarized waves. As a result, the low frequency region turns into aliasing, and is superimposed on the FM batch conversion signal, leading to signal degradation. Therefore, a technology for detecting quality degradation of an FM batch conversion signal due to aliasing is desired.

In view of the above circumstances, the present invention aims to provide a technology by which quality degradation of an FM batch conversion signal can be detected in an optical transmission device using an FM batch conversion technique.

### Solution to Problem

An aspect of the present invention is an optical transmission device that includes: an FM batch conversion unit that performs FM batch conversion on a carrier signal input from the outside, to generate an FM batch conversion signal; a signal branching unit that causes the FM batch conversion signal to branch into a first path and a second path; an optical transmission unit that is provided in the first path, converts the FM batch conversion signal into an optical signal, and transmits the optical signal to the outside; and a detection unit that is provided in the second path, and detects quality degradation of the FM batch conversion signal on the basis of the signal level of the FM batch conversion signal.

An aspect of the present invention is a signal detection method that includes: generating an FM batch conversion signal by performing FM batch conversion on a carrier signal input from the outside; converting the FM batch conversion signal into an optical signal and outputting the optical signal to the outside, the FM batch conversion signal having been branched by a signal branching unit that causes the FM batch conversion signal to branch; and detecting quality degradation of the FM batch conversion signal, on the basis of the signal level of the branched FM batch conversion signal.

### Advantageous Effects of Invention

The present invention enables detection of quality degradation of an FM batch conversion signal in an optical transmission device that uses an FM batch conversion technique.

### BRIEF DESCRIPTION OF DRAWINGS

FIG. 1 is a block diagram illustrating a specific example of the functional configuration of an optical transmission device according to the present invention.

FIG. 2 is a flowchart illustrating a flow of processing to be performed by the optical transmission device according to an embodiment.

FIG. 3 is a diagram for explaining a first method for detecting quality degradation of an FM batch conversion signal according to the embodiment.

FIG. 4 is a diagram for explaining a second method for detecting quality degradation of an FM batch conversion signal according to the embodiment.

FIG. 5 is a diagram for explaining a third method for detecting quality degradation of an FM batch conversion signal according to the embodiment.

FIG. 6 is a configuration diagram of an optical transmission device in a conventional communication system to which an FM batch conversion technique is applied.

### DESCRIPTION OF EMBODIMENTS

The following is a description of an embodiment of the present invention, with reference to the drawings.

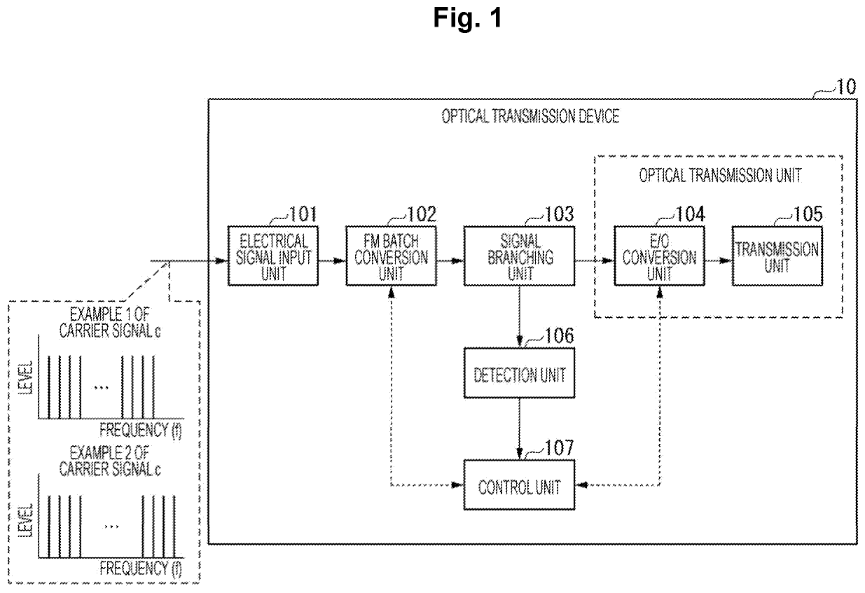

FIG. 1 is a block diagram illustrating a specific example of the functional configuration of an optical transmission device 10 according to the present invention.

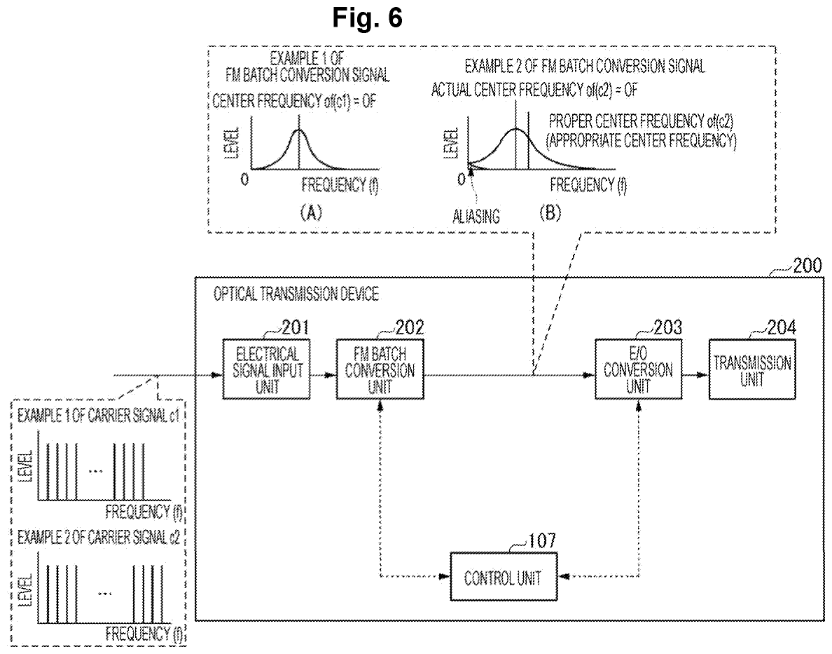

The optical transmission device 10 performs FM batch conversion on a carrier signal input from the outside, to generate an FM batch conversion signal that is a broadband FM signal. The carrier signal input from the outside is a carrier signal obtained from a video signal, for example. The optical transmission device 10 includes an electrical signal input unit 101, an FM batch conversion unit 102, a signal branching unit 103, an E/O conversion unit 104, a transmission unit 105, a detection unit 106, and a control unit 107. Relative to the optical transmission device 200 illustrated in FIG. 6, the optical transmission device 10 differs from the optical transmission device 200 in that the signal branching unit 103 and the detection unit 106 are added.

The electrical signal input unit 101 receives an input of a carrier signal that is an electrical signal. The electrical signal input unit 101 is an interface of a coaxial cable, for example.

The FM batch conversion unit 102 performs FM batch conversion on the one or more input carrier signals, to generate one FM batch conversion signal.

The signal branching unit 103 causes the FM batch conversion signal generated by the FM batch conversion unit 102 to branch into a first path and a second path. The first path is a path that connects the signal branching unit 103 and the E/O conversion unit 104. The second path is a path that connects the signal branching unit 103 and the detection unit 106.

The E/O conversion unit 104 converts the FM batch conversion signal, which is an electrical signal input via the first path, into an optical signal.

The transmission unit 105 transmits the optical signal converted by the E/O conversion unit 104 to the outside. The E/O conversion unit 104 and the transmission unit 105 are one mode of an optical transmission unit.

The detection unit 106 detects quality degradation of the FM batch conversion signal, on the basis of the signal level of the FM batch conversion signal input via the first path. Quality degradation of the FM batch conversion signal is quality degradation due to aliasing occurring in the FM batch conversion signal, for example.

The control unit 107 controls the respective functional units. For example, the control unit 107 issues an alert in a case where quality degradation of the FM batch conversion signal is detected by the detection unit 106.

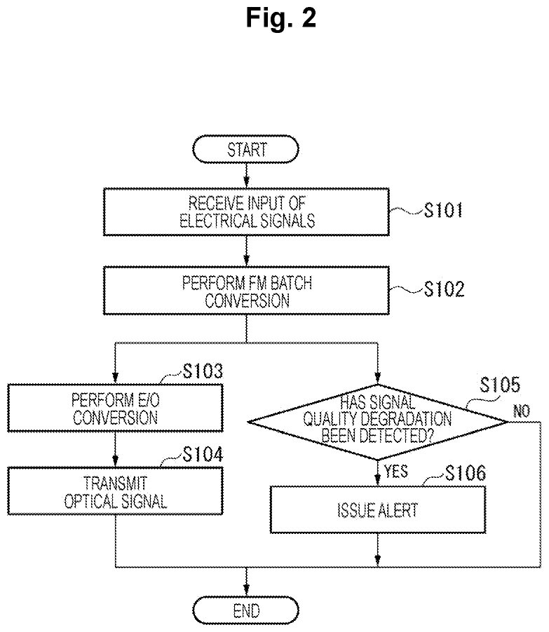

FIG. 2 is a flowchart illustrating a flow of processing to be performed by the optical transmission device 10 according to the embodiment.

The electrical signal input unit 101 receives an input of one or more carrier signals that are electrical signals (step S101). The electrical signal input unit 101 outputs the input carrier signals to the FM batch conversion unit 102. The FM batch conversion unit 102 performs FM batch conversion on the carrier signals output from the electrical signal input unit 101, to generate one FM batch conversion signal (step S102). The FM batch conversion unit 102 outputs the generated FM batch conversion signal to the signal branching unit 103. The FM batch conversion signal input to the signal branching unit 103 is output to the first path and the second path. As a result, the FM batch conversion signal is input to the E/O conversion unit 104 via the first path, and is input to the detection unit 106 via the second path.

In the description below, the processes in step S103 and step S105 will be explained in this order, but the processes in step S103 and step S105 may be performed in parallel. The E/O conversion unit 104 converts the FM batch conversion signal input via the first path, into an optical signal (step S103). The E/O conversion unit 104 outputs the optical signal to the transmission unit 105. The transmission unit 105 outputs the optical signal output from the E/O conversion unit 104 to an external transmission path (step S104).

Meanwhile, the detection unit 106 determines whether quality degradation of the FM batch conversion signal has been detected, on the basis of the signal level of the FM batch conversion signal input via the second path (step S105). If the detection unit 106 does not detect any quality degradation of the FM batch conversion signal (step S105: NO), the optical transmission device 10 does not perform any particular processing.

If the detection unit 106 detects quality degradation of the FM batch conversion signal (step S105: YES), the control unit 107 issues an alert (step S106).

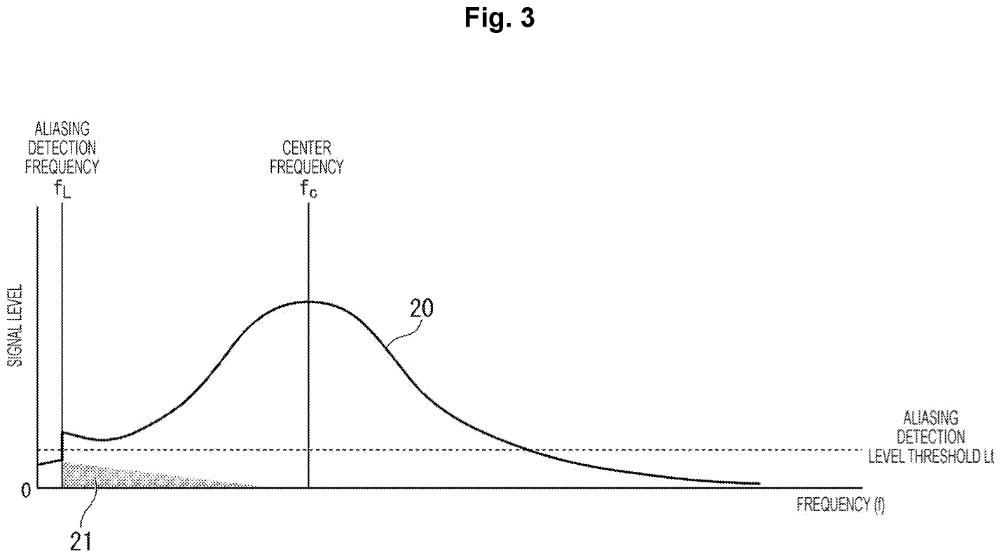

Next, methods of quality degradation detection to be performed by the detection unit 106 are described with reference to FIGS. 3 to 5. In FIGS. 3 to 5, the abscissa axis indicates frequency (f), and the ordinate axis indicates signal level. Waveforms 20 illustrated in FIGS. 3 to 5 represent the waveforms of FM batch conversion signals. Note that FIGS. 3 to 5 illustrate examples in which an aliasing component 21 is superimposed on the waveform 20 of an FM batch conversion signal.

### (First Detection Method)

FIG. 3 is a diagram for explaining a first method for detecting quality degradation of an FM batch conversion signal according to the embodiment.

First, the detection unit 106 measures the signal level of an aliasing detection frequency f_{L} [Hz] (first frequency) in the waveform 20 of an FM batch conversion signal. The aliasing detection frequency f_{L} [Hz] is a direct current (DC) component appearing near 0, and an aliasing component appears after the DC component. Note that, in FIG. 3 and the drawings that follow, the aliasing component 21 and changes in signal level due to the influence of the aliasing component 21 are shown in an exaggerated manner to facilitate understanding of the description. Next, the detection unit 106 compares the measured signal level of the aliasing detection frequency f_{L} with an aliasing detection level threshold Lt (first threshold).

In a case where the signal level of the aliasing detection frequency f_{L} is equal to or higher than the aliasing detection level threshold Lt, the detection unit 106 determines that there is aliasing in the FM batch conversion signal. That is, the detection unit 106 determines that the quality of the FM batch conversion signal has been degraded.

In a case where the signal level of the aliasing detection frequency f_{L} is lower than the aliasing detection level threshold Lt, on the other hand, the detection unit 106 determines that there is no aliasing in the FM batch conversion signal. That is, the detection unit 106 does not detect any quality degradation in the FM batch conversion signal. The aliasing detection frequency f_{L} and the aliasing detection level threshold Lt may be held beforehand in the optical transmission device 10, or may be given as setting values from an external device.

### (Second Detection Method)

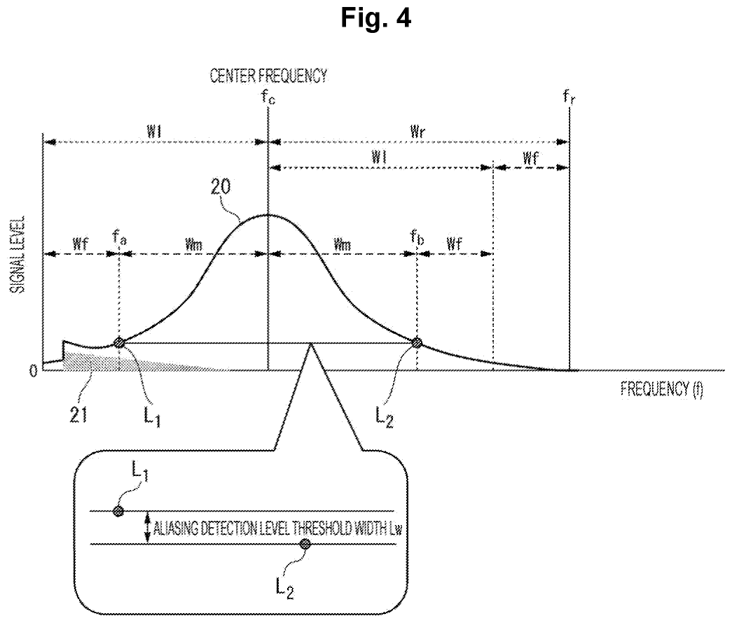

FIG. 4 is a diagram for explaining a second method for detecting quality degradation of an FM batch conversion signal according to the embodiment. The second detection method is effective in a case where the aliasing detection frequency f_{L} and the aliasing detection level threshold Lt cannot be determined. The second detection method takes advantage of horizontally symmetric properties that are characteristics of an FM batch conversion signal.

First, the detection unit 106 calculates a first frequency width Wl and a second frequency width Wr in the waveform 20 of an FM batch conversion signal. The first frequency width Wl indicates the frequency width from the frequency 0 to the center frequency f_{c}. The second frequency width Wr indicates the frequency width from the center frequency f_{c} to the frequency at the position where the signal level becomes 0 at a higher frequency than the center frequency f_{c}.

The detection unit 106 calculates the first frequency width Wl and the second frequency width Wr, on the basis of Equation (1) and Equation (2) shown below.

First frequency width Wl=|f_{c}−0| (1)

Second frequency width Wr=|fᵣ−f_{c}| (2)

In Equation (2) shown above, fᵣ represents the frequency at the position where the signal level becomes 0 at a higher frequency than the center frequency f_{c}. Using the calculated first frequency width Wl and second frequency width Wr, the detection unit 106 next calculates a third frequency width Wf and a fourth frequency width Wm on the basis of Equation (3) and Equation (4) shown below.

Third frequency width Wf=|Wr−Wl| (3)

Fourth frequency width Wm=|Wl−Wf| (4)

The detection unit 106 then measures the signal level L₁ (the level of the frequency |f_{c}−Wm|) of the frequency fₐ (first frequency) at the position obtained by subtracting the fourth frequency width Wm from the center frequency f_{c}, and the signal level L₂ (the level of the frequency |f_{c}+Wm|) of the frequency f_{b} (second frequency) at the position obtained by adding the fourth frequency width Wm to the center frequency f_{c}. Here, the frequency fₐ and the frequency f_{b} are frequencies at positions horizontally symmetrical with respect to the center frequency f_{c}. In this manner, by the second detection method, the detection unit 106 defines the frequencies at the positions separated from the center frequency f_{c} by the fourth frequency width Wm as the frequencies fₐ and f_{b}, respectively.

The detection unit 106 then compares the subtraction value obtained by subtracting the signal level L₂ from the signal level L₁, with the aliasing detection level threshold width Lw (first threshold). In a case where the subtraction value is greater than the aliasing detection level threshold width Lw (|L₁−L₂|>Lw), the detection unit 106 determines that there is aliasing in the FM batch conversion signal. That is, the detection unit 106 determines that the quality of the FM batch conversion signal has been degraded.

In a case where the subtraction value is equal to or smaller than the aliasing detection level threshold width Lw (|L₁−L₂|<Lw), on the other hand, the detection unit 106 determines that there is no aliasing in the FM batch conversion signal. That is, the detection unit 106 does not detect any quality degradation in the FM batch conversion signal. The aliasing detection level threshold width Lw may be held beforehand in the optical transmission device 10, or may be given as a setting value from an external device.

In a case where there is aliasing in the FM batch conversion signal, the frequency component generated by the aliasing is superimposed on the frequency fₐ. Therefore, the signal level L₁ of the frequency fₐ is higher than the signal level L₂ of the frequency f_{b}. Accordingly, by determining whether the subtraction value is equal to or greater than the aliasing detection level threshold width Lw, the detection unit 106 can determine whether there is aliasing in the FM batch conversion signal.

### (Third Detection Method)

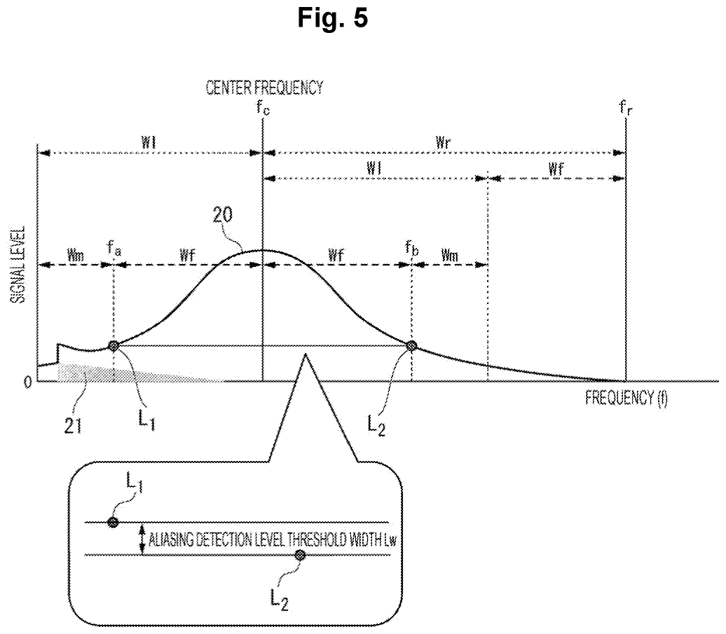

FIG. 5 is a diagram for explaining a third method for detecting quality degradation of an FM batch conversion signal according to the embodiment. By the second detection method, in a case where the third frequency width Wf>the fourth frequency width Wm, there is a possibility that the signal level caused by aliasing is small and is difficult to be distinguished. Therefore, the third detection method is effective in a case where the third frequency width Wf>the fourth frequency width Wm. The third detection method also takes advantage of the horizontally symmetric properties of an FM batch conversion signal.

The detection unit 106 measures the signal level L₁ (the level of the frequency |f_{c}−Wf|) of the frequency fₐ at the position obtained by subtracting the third frequency width Wf from the center frequency f_{c}, and the signal level L₂ (the level of the frequency |f_{c}+Wf|) of the frequency f_{b} at the position obtained by adding the third frequency width Wf to the center frequency f_{c}. In this manner, by the third detection method, the detection unit 106 defines the frequencies at the positions separated from the center frequency f_{c} by the third frequency width Wf as the frequencies fₐ and f_{b}, respectively.

The detection unit 106 then compares the subtraction value obtained by subtracting the signal level L₂ from the signal level L₁, with the aliasing detection level threshold width Lw. In a case where the subtraction value is greater than the aliasing detection level threshold width Lw (|L₁−L₂|>Lw), the detection unit 106 determines that there is aliasing in the FM batch conversion signal. That is, the detection unit 106 determines that the quality of the FM batch conversion signal has been degraded.

In a case where the subtraction value is equal to or smaller than the aliasing detection level threshold width Lw (|L₁−L₂|<Lw), on the other hand, the detection unit 106 determines that there is no aliasing in the FM batch conversion signal. That is, the detection unit 106 does not detect any quality degradation in the FM batch conversion signal.

As described above, the second and third detection methods are the same at least in that the detection unit 106 determines that the quality of the FM batch conversion signal has been degraded in a case where the difference value between the signal level L₁ of the frequency fₐ for detecting aliasing in the FM batch conversion signal and the signal level L₂ of the frequency f_{b} at the position horizontally symmetrical with the frequency fₐ with respect to the center frequency f_{c} is greater than the aliasing detection level threshold width Lw.

As can be seen from FIGS. 4 and 5, the second and third detection methods cannot be implemented in a case where the third frequency width Wf>the first frequency width Wl.

One of the first detection method, the second detection method, and the third detection method described above may be set as the method to be used in the detection unit 106, or the first detection method, the second detection method, and the third detection method may be implemented in this order. For example, in a case where the detection unit 106 implements the methods in order, if any quality degradation has not been detected by all the methods of the first detection method, the second detection method, and the third detection method, the detection unit 106 determines that any quality degradation of the FM batch conversion signal has not been detected. If quality degradation has been detected by any one of the methods of the first detection method, the second detection method, and the third detection method, the detection unit 106 determines that quality degradation of the FM batch conversion signal has been detected.

With the optical transmission device 10 designed as described above, an FM batch conversion signal obtained through FM batch conversion is branched and input to the detection unit 106. On the basis of the signal level of the input FM batch conversion signal, the detection unit 106 detects quality degradation of the FM batch conversion signal. That is, aliasing of the FM batch conversion signal is detected. Thus, in the optical transmission device 10 using the FM batch conversion technique, it is possible to detect quality degradation of an FM batch conversion signal.

The optical transmission device 10 measures the signal level of the aliasing detection frequency f_{L} for detecting aliasing that is a cause of quality degradation in an FM batch conversion signal, and, in a case where the signal level of the aliasing detection frequency f_{L} is equal to or higher than the first threshold, determines that the quality of the FM batch conversion signal has been degraded. The aliasing detection frequency f_{L} is a frequency at which noise due to aliasing is superimposed. Therefore, in a case where there is aliasing in the FM batch conversion signal, the signal level of the aliasing detection frequency f_{L} is higher than that in a case where there is no aliasing. In view of this, the optical transmission device 10 detects whether where is aliasing that is a cause of quality degradation, depending on whether the signal level of the aliasing detection frequency f_{L} is equal to or higher than the aliasing detection level threshold Lt. Thus, in the optical transmission device 10 using the FM batch conversion technique, it is possible to detect quality degradation of an FM batch conversion signal.

The optical transmission device 10 issues an alert in a case where quality degradation of an FM batch conversion signal is detected. Thus, the operator can notice the occurrence of aliasing, and it is possible to prevent inputting of an unexpected input signal.

Some functional units (for example, the detection unit 106 and the control unit 107) included in the optical transmission device 10 in the embodiment described above may be implemented by a computer. In that case, a program for implementing these functions may be recorded in a computer-readable recording medium, and the program recorded in the recording medium may be read and executed by a computer system to implement the functions. Note that the “computer system” mentioned herein includes an OS and hardware such as a peripheral device. Also, the “computer-readable recording medium” refers to a portable medium such as a flexible disk, a magneto-optical disk, a ROM, or a CD-ROM, or a storage device such as a hard disk included in a computer system. Further, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside a computer system serving as a server or a client in that case. Also, the above program may be for achieving some of the functions described above, may be formed with a combination of the functions described above and a program already recorded in a computer system, or may be formed with the use of a programmable logic device such as a field programmable gate array (FPGA).

Although the embodiment of the present invention has been described in detail with reference to the drawings, specific configurations are not limited to the embodiment, and include designs and the like without departing from the scope of the invention.

### INDUSTRIAL APPLICABILITY

The present invention can be applied to technologies using an FM batch conversion technique.

### REFERENCE SIGNS LIST

10 optical transmission device
101 electrical signal input unit
102 FM batch conversion unit
103 signal branching unit
104 E/O conversion unit
105 transmission unit
106 detection unit
107 control unit

1. An optical transmission device comprising:
an FM batch conversion unit that performs FM batch conversion on a carrier signal input from outside, to generate an FM batch conversion signal;
a signal branching unit that causes the FM batch conversion signal to branch into a first path and a second path;
an optical transmission unit that is provided in the first path, converts the FM batch conversion signal into an optical signal, and transmits the optical signal to outside; and
a detection unit that is provided in the second path, and detects quality degradation of the FM batch conversion signal on a basis of a signal level of the FM batch conversion signal.

2. The optical transmission device according to claim 1, wherein
the detection unit measures a signal level of a first frequency for detecting aliasing that is a cause of the quality degradation in the FM batch conversion signal, and, when the signal level of the first frequency is equal to or higher than a first threshold, determines that quality of the FM batch conversion signal has been degraded.

3. The optical transmission device according to claim 1, wherein
the detection unit determines that quality of the FM batch conversion signal has been degraded, when a difference value between a signal level of a first frequency for detecting aliasing that is a cause of the quality degradation and a signal level of a second frequency at a position horizontally symmetrical with the first frequency with respect to a center frequency of the FM batch conversion signal is greater than a first threshold in the FM batch conversion signal.

4. The optical transmission device according to claim 3, wherein
the detection unit
calculates a first frequency width from a frequency 0 to the center frequency in the FM batch conversion signal,
calculates a second frequency width from the center frequency to a position at which the signal level becomes 0 at a higher frequency than the center frequency;
calculates a third frequency width by subtracting the first frequency width from the calculated second frequency width;
calculates a fourth frequency width by subtracting the third frequency width from the calculated first frequency width; and,
when the third frequency width is equal to or less than the fourth frequency width, frequencies at positions separated from the center frequency by the fourth frequency width are determined to be the first frequency and the second frequency.

5. The optical transmission device according to claim 3, wherein
the detection unit
calculates a first frequency width from a frequency 0 to the center frequency in the FM batch conversion signal,
calculates a second frequency width from the center frequency to a position at which the signal level becomes 0 at a higher frequency than the center frequency;
calculates a third frequency width by subtracting the first frequency width from the calculated second frequency width;
calculates a fourth frequency width by subtracting the third frequency width from the calculated first frequency width; and,
when the third frequency width is greater than the fourth frequency width, frequencies at positions separated from the center frequency by the third frequency width are determined to be the first frequency and the second frequency.

6. The optical transmission device according to claim 1, further comprising
a control unit that issues an alert when the detection unit detects aliasing in the FM batch conversion signal.

7. A signal detection method comprising:
generating an FM batch conversion signal by performing FM batch conversion on a carrier signal input from outside;
converting the FM batch conversion signal into an optical signal and outputting the optical signal to outside, the FM batch conversion signal having been branched by a signal branching unit that causes the FM batch conversion signal to branch; and
detecting quality degradation of the FM batch conversion signal, on a basis of a signal level of the branched FM batch conversion signal.
